(19) United States
(12) Patent Application Publication
(10) Pub. No.: US 2026/0072756 A1
(43) Pub. Date: Mar. 12, 2026

(54) HASH-BASED ALLOCATION OF APPLICATIONS TO VIRTUALIZED COMPUTING ENVIRONMENTS

(71) Applicant: NVIDIA Corporation, Santa Clara, CA (US)

(72) Inventors: Paul Albert Lalonde, Santa Clara, CA (US); Bipin Todur, Santa Clara, CA (US)

(21) Appl. No.: 18/830,416

(22) Filed: Sep. 10, 2024

(51) Int. Cl. G06F 9/50

(52) U.S. Cl. CPC G06F 9/5077; G06F 9/5055

(57) ABSTRACT

Apparatuses, systems, and techniques for allocating application hosting platforms in a virtualized computing environment. A method can include assigning a first set of virtualized computing environments to a first application based on one or more characteristics of the first application, and assigning a second set of virtualized computing environments to a second application of the plurality of applications based on one or more characteristics of the second application, the second set of virtualized computing environments being different than the first set of virtualized computing environments. The method can include causing, in response to a request to execute the first application, an instance of the first application to be executed on a virtualized computing environment of the first set of virtualized computing environments using data stored in a cache of the virtualized computing environment.

### TECHNICAL FIELD

At least one embodiment pertains to allocating applications to virtualized computing environments. For example, at least one embodiment pertains to processors or computing systems used to provide and enable hash-based allocation of applications to virtualized computing environments based on characteristics of the applications, according to various novel techniques described herein.

### BACKGROUND

In a cloud computing environment, a user can access and stream software applications (such as gaming applications) via an application hosting platform at their local client device. The software application can load several files during a launch sequence, including assets, textures, graphics, data associated with the user, etc. Loading all of the files associated with the software application can take a significant amount of time. An application hosting platform can load the software application upon a user request. However, such techniques can cause users to wait a significant amount of time before the software application is ready for streaming. This can reduce the overall user experience.

### BRIEF DESCRIPTION OF DRAWINGS

Various embodiments in accordance with the present disclosure will be described with reference to the drawings, in which:

FIG. 1 illustrates a block diagram of an example cloud computing environment system architecture, in accordance with at least at least one embodiment.

FIG. 2 illustrates a block diagram of a system facilitating hash-based application-to-server allocation in a cloud environment, in accordance with at least at least one embodiment.

FIG. 3 illustrates an example ring-based allocation of applications to virtualized computing environments using application characteristics, in accordance with at least at least one embodiment.

FIG. 4 illustrates an example ring-based allocation of applications to virtualized computing environments using virtual computing environment availability, in accordance with at least at least one embodiment.

FIG. 5 illustrates an example allocation of applications to virtualized computing environments using multiple rings, in accordance with at least at least one embodiment.

FIG. 6 illustrates a flow diagram of an example method for allocating applications to virtualized computing environments, in accordance with at least at least one embodiment.

FIG. 7A illustrates an inference and/or training logic, in accordance with at least at least one embodiment.

FIG. 7B illustrates an inference and/or training logic, in accordance with at least at least one embodiment.

FIG. 8 illustrates an example data center system, in accordance with at least at least one embodiment.

FIG. 9 illustrates a computer system, in accordance with at least at least one embodiment.

FIG. 10 illustrates a computer system, in accordance with at least at least one embodiment.

FIG. 11 illustrates at least portions of a graphics processor, in accordance with at least at least one embodiment.

FIG. 12 illustrates at least portions of a graphic processor, in accordance with at least at least one embodiment.

FIG. 13 illustrates an example data flow diagram for an advanced computing pipeline, in accordance with at least at least one embodiment.

FIG. 14 illustrates a system diagram for an example system for training, adapting, instantiating and deploying machine learning models in an advanced computing pipeline, in accordance with at least some embodiment.

FIGS. 15A and 15B illustrate a data flow diagram for a process to train a machine learning model, as well as client-server architecture to enhance annotation tools with pre-trained annotation models, in accordance with at least at least one embodiment.

### DETAILED DESCRIPTION

Applications may be hosted in a cloud computing environment (e.g., a cloud-based gaming platform) by an application hosting platform. An instance of an application hosted by the application hosting platform can be provided to a client device via a virtualized computing environment (e.g., a virtual machine (VM) or a container). A user can access the application (e.g., a gaming application, a collaborative content creation application, a streaming application, a multimedia application, an entertainment application, an interactive application (which may include on or more of these other types of applications), or any other type of application) on a client device (e.g., a computer, a gaming console, a mobile phone, or a smart phone) via the application hosting platform. For example, a user can access (e.g., log into) the application hosting platform and select a gaming application for access by their client device. The application hosting platform can communicate with the gaming application through a set of application programming interfaces (APIs) and can begin to load an instance of the gaming application to the virtualized computing environment for the user device to access. For example, the application hosting platform can launch the gaming application to the virtualized computing environment with a command line when the user selects the gaming application. To launch the gaming application to the virtualized computing environment, the application hosting platform can begin to load the gaming application files for the user to the virtualized computing environment.

An instance of the gaming application may be assigned to the virtualized computing environment in response to the user selecting the gaming application on the client device that is connected to the application hosting platform. The application hosting platform may require significant time to download the instance of the gaming application data from a storage server to the virtualized computing environment. For example, the application hosting platform can take several seconds or several minutes to download generic data and user data associated with the gaming application to the virtualized computing environment. During this time, the user may be unable to access the gaming application and may be presented with a loading screen while the virtualized computing environment is getting ready for user interaction with the gaming application. After several seconds or several minutes, the virtualized computing environment can be ready and the user can access the gaming application and main menu. The overall user experience of interacting with the instance of the gaming application can be negatively impacted due to the long delay between the user selecting the gaming application and the user being able to access the instance of the gaming application.

In some examples, an instance of the gaming application can be randomly assigned to a virtualized computing environment (e.g., a VM) from a pool of available virtualized computing environments (e.g., available VMs). However, randomly assigning the instance of the gaming application to the virtualized computing environment from the pool of available virtualized computing environments may require that all available virtualized computing environments remain online for extended periods of time. This may result in increased power consumption in the cloud computing platform. In some other examples, the instance of the gaming application may be assigned to a particular virtualized computing environment. For example, each instance of the gaming application may be assigned to the same virtualized computing environment each time that the gaming application is selected. However, assigning each instance of the gaming application to the same virtualized computing environment may result in increased wear leveling at the virtualized computing environments. For example, virtualized computing environments executing instances of more popular gaming applications may fail more quickly than virtualized computing environments executing instances of less popular gaming applications. In some cases, different applications may load the CPU, GPU, or other storage in different ways. Therefore, having a fixed application in a virtualized computing environment may result in increased wear and tear within the virtualized computing environment.

Aspects of the present disclosure address the above and other deficiencies by providing methods and systems that allocate virtualized computing environments to applications (e.g., gaming applications, a collaborative content creation application, a streaming application, a multimedia application, an entertainment application, an interactive application (which may include on or more of these other types of applications), or any other type of application) and store application data in respective caches of the virtualized computing environments. For example, multiple gaming applications provided by an application hosting platform can be identified, and for each gaming application, one or more virtualized computing environments (e.g., virtual machines or containers) can be allocated to the gaming application and application data for the gaming application can be stored in the caches of the one or more virtualized computing environments. In some examples, multiple virtualized computing environments may be associated with a unique identifier for a particular gaming application. When the gaming application is selected by a user associated with a client device that is connected to the application hosting platform, an instance of the gaming application may be executed on a virtualized computing environment associated with the unique identifier and using application data that is stored in the cache of the virtualized computing environment.

In some examples, a provisioning manager of a cloud computing platform may organize some or all of the virtualized computing environments in a ring of virtualized computing environments. Additionally, the provisioning manager may identify a number of gaming applications that are capable of being executed by the cloud computing platform and may organize the gaming applications in the ring. The provisioning manager may organize the gaming applications in the ring based on one or more characteristics of the gaming applications. For example, gaming applications that are more popular may be assigned to a larger portion of the ring than gaming applications that are less popular. Therefore, the gaming applications that are more popular may be assigned a higher quantity of virtualized computing environments than the gaming applications that are less popular. Further, the provisioning manager may store application data associated with the gaming applications in respective caches of the virtualized computing environments based on the locations of the gaming applications and the virtualized computing environments in the ring. When the user selects a gaming application, an instance of the gaming application may be executed on one of the virtualized computing environments based on the locations of the gaming applications and the virtualized computing environments in the ring.

In one example, the application hosting platform may host four gaming applications, where each gaming application is associated with a unique identifier. Additionally, the cloud computing platform may provide twenty virtualized computing environments that are capable of executing instances of the four gaming applications. The virtualized computing environments may generally be equally distributed along the ring. The provisioning manager may organize the gaming applications in the ring based on one or more characteristics of the gaming applications, such as a popularity of the gaming applications. For example, the provisioning manager may assign thirty percent of the ring to a first gaming application, forty percent of the ring to a second gaming application, ten percent of the ring to a third gaming application, and twenty percent of the ring to a fourth gaming application. Additionally, the provisioning manager may assign the virtualized computing environments to the gaming applications based on the respective locations of the gaming applications and the virtualized computing environments in the ring. For example, the provisioning manager may assign six virtualized computing environments to the first application, eight virtualized computing environments to the second application, two virtualized computing environments to the third gaming application, and four virtualized computing environments to the fourth gaming application. Further, the provisioning manager may store data associated with the gaming applications in the respective caches of the virtualized computing environments. For example, the provisioning manager may store data associated with the first gaming application in the caches of the corresponding six virtualized computing environments, store data associated with the second gaming application in the caches of the corresponding eight virtualized computing environments, assign data associated with the third gaming application in the caches of the corresponding two virtualized computing environments, and store data associated with the fourth gaming application in the caches of the corresponding four virtualized computing environments. When a user selects one of the gaming applications, an instance of the gaming application may be executed on a corresponding virtualized computing environment using the data stored in the cache of the virtualized computing environment.

In some examples, the provisioning manager may activate or deactivate the virtualized computing environments based on one or more parameters, such as based on a time parameter. For example, the provisioning manager may determine that gaming applications are executed more frequently during a first time of day (such as in the evening) than during a second time of day (such as in the morning). The provisioning manager may activate most or all of the virtualized computing environments during the first time of day in order to enable the gaming applications to be executed more quickly during the first time of day. Additionally, or alternatively, the provisioning manager may deactivate some of the virtualized computing environments during the second time of day in order to reduce a power consumption by the virtualized computing environments. In some examples, the provisioning manager may re-assign a virtualized computing environment from a first gaming application to a second gaming application based on one or more conditions. For example, based on detecting that a second gaming application is becoming more popular than a first gaming application, the provisioning manager may reassign a unique identifier of the second gaming application from one virtualized computing environment to another virtualized computing environment. Additionally, the provisioning manager may delete application data associated with the second gaming application from the cache of the virtualized computing environment and may store application data associated with the second gaming application in a cache of the other virtualized computing environment. In some examples, the cache of each virtualized computing environment may store data for a single gaming application. In some other examples, the cache of at least one virtualized computing environment may store data for multiple gaming applications. This may enable the virtualized computing environment to efficiently host any game of the multiple gaming applications.

Some advantages of the present disclosure include decreased loading times for gaming applications in a cloud computing platform. For example, when a user initiates a gaming application, an instance of the gaming application may be executed on a virtualized computing environment using data stored in a cache of the virtualized computing environment. Loading gaming applications more quickly improves a user experience. Some advantages of the present disclosure also include improved balancing of cache sizes and bandwidth usage. For example, virtualized computing environments with larger caches and smaller bandwidths may store more gaming application data in the caches of the virtualized computing environments, whereas virtualized computing environments with smaller caches and larger bandwidths may store less data in the caches of the virtualized computing environments and enable more data to be accessed from a data store of the cloud computing platform during execution of a gaming application. Some advantages of the present disclosure further include assigning virtualized computing environments to the gaming applications based on popularities of the gaming applications, and activating and deactivating virtualized computing environments based on one or more parameters, such as a time of day parameter. This may reduce power consumption in the cloud computing platform. Some advantages of the present disclosure further include enabling gaming applications to be distributed among virtualized computing environments more evenly, thereby reducing wear leveling of the virtualized computing environments.

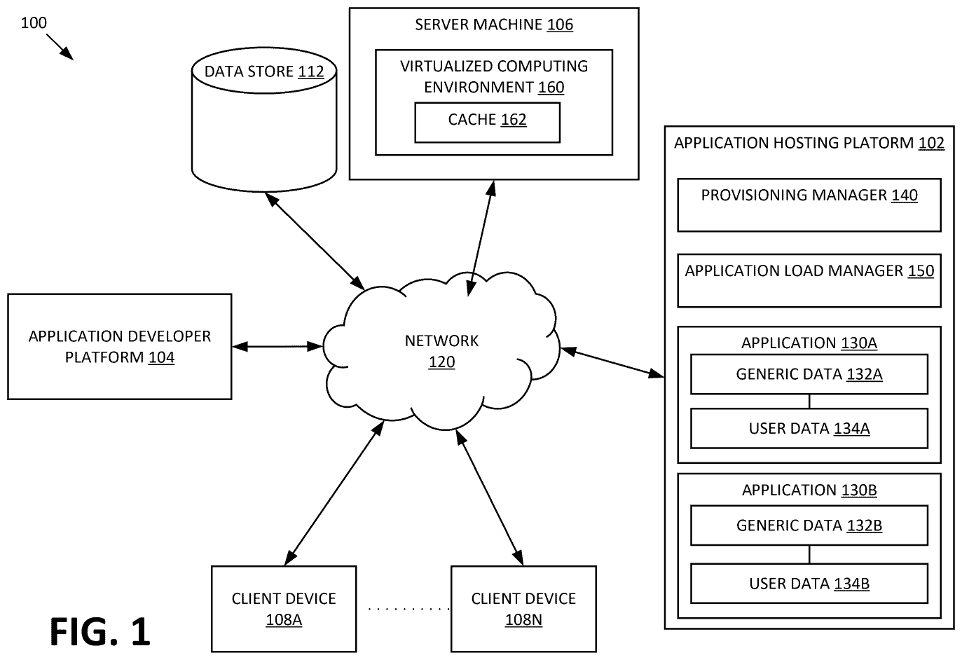

FIG. 1 illustrates a block diagram of an example system architecture 100, according to at least one embodiment. The system architecture 100 (also referred to as “system” herein) includes application hosting platform 102, application developer platform 104, server machine 106, client devices 108A-N (collectively and individually referred to as client device(s) 108), and data store 112, each connected to a network 120. In implementations, network 120 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 112 is a persistent storage that is capable of storing content items as well as data structures to tag, organize, and index the content items. Data store 112 may be hosted by one or more storage devices, such as main memory, magnetic or optical storage based disks, tapes or hard drives, NAS, SAN, and so forth. In some implementations, data store 112 may be a network-attached file server, while in other embodiments data store 112 may be some other type of persistent storage such as an object-oriented database, a relational database, and so forth, that may be hosted by platform 102 or one or more different machines coupled to the platform 102 via network 120.

Application hosting platform 102 may be configured to host files of one or more applications (e.g., application 130A, application 130B, etc.) provided by an application developer (e.g., via application developer platform 104). Application developer platform 104 may be used by an application developer (e.g., a user, company, organization, etc.). For example, an application developer may be a video game developer that develops a video game (represented by an application 130) for users to interact with on client devices 108. Application hosting platform 102 may provide users with access to an application 130 (or an instance of an application 130) provided by application developer platform 104 via a respective client device 108A-N. For example, application hosting platform 102 may allow users to consume, upload, download, and/or search for applications 130. In at least one embodiment, application hosting platform 102 may have a website (e.g., one or more webpages) or a client application or component that may be used to provide users with access to applications 130. In at least one embodiment, each application 130 may consist of generic data 132 (e.g., data exclusive of user data) and user data 134—e.g., generic data 132A and user data 134A of application 130A, generic data 132B and user data 134B of application 130B, etc. In at least one embodiment, the application hosting platform 102 can be an example of a cloud-hosted gaming service platform, a cloud-hosted collaborative content creation platform for heterogeneous content creation applications, a video streaming hosting platform, a testing platform for simulated or augmented content, a machine learning training platform, a machine learning deployment platform, or a video conferencing hosting platform. In at least one embodiment, the application 130 (or instance of application 130) can be an example of a gaming application, a video conferencing application, a content creation application, a cloud-hosted application, a collaborative content creation application, a cloud-hosted collaborative content creation application, a video streaming application, a machine learning application, or a simulation application.

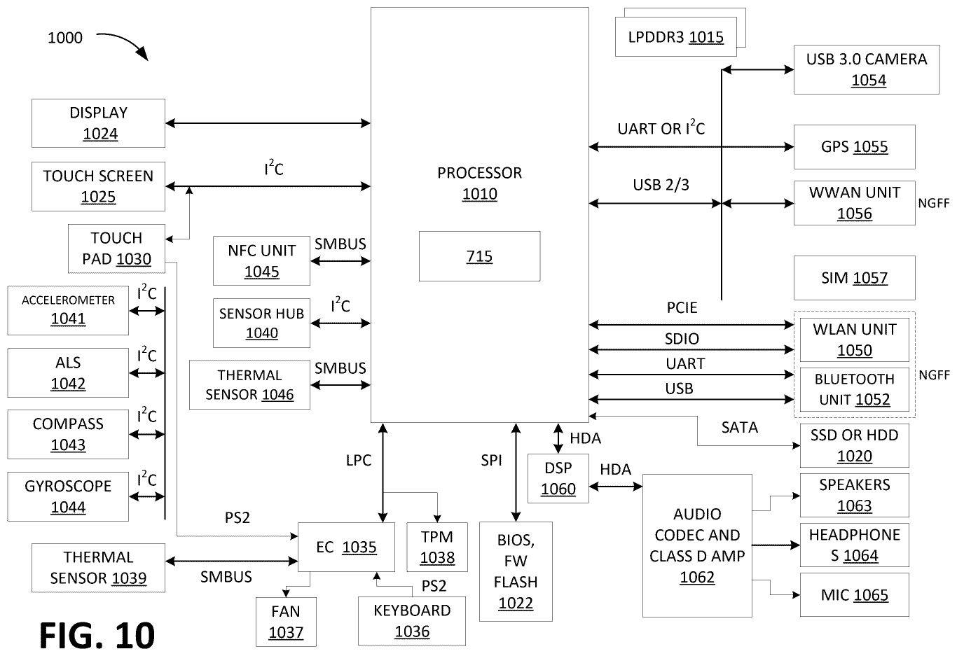

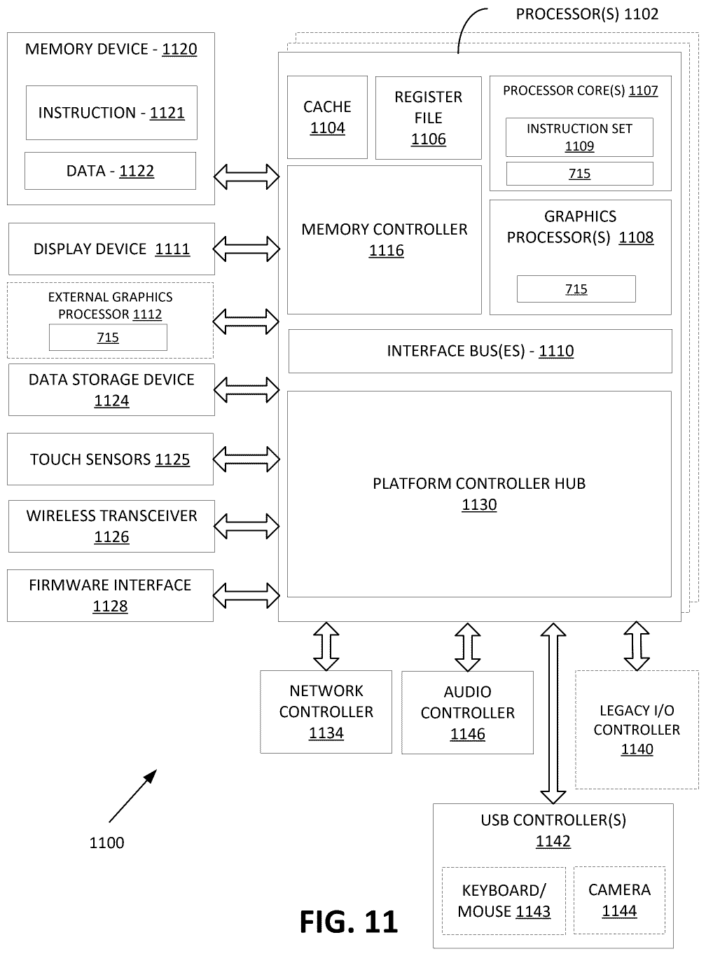

In at least one embodiment, server 106 may host a virtualized computing environment 160 running an instance of application 130. For example, server 106 may be a computer system that includes one or more physical devices (e.g., a processing device (e.g., a GPU), memory, one or more I/O devices, etc.) and a hypervisor and/or a host operating system that manage one or more virtualized computing environments 160. A virtualized computing environment 160 may correspond, for example, to a virtual machine running a guest operating system and one or more guest applications including an instance of application 130, or a container running an application such as an instance of application 130. One or more servers 106 may be provided and each server 106 may host one or more virtualized computing environments 160. In at least one embodiment, each server 106 may correspond to computer system 900 and/or computer system 1000 described with respect to FIGS. 9 and 10.

Application hosting platform 102 may include provisioning manager 140 that assigns applications 130 (e.g., gaming applications) to particular sets of virtualized computing environments 160. In at least one embodiment, provisioning manager 140 assigns applications 130 to particular sets of virtualized computing environments 160 by organizing some or all of the virtualized computing environments 160 in a ring, and organizing applications 130 in the ring based on characteristics of the applications 130. For example, applications 130 that are more popular may be assigned to a larger portion of the ring than applications 130 that are less popular. Therefore, the applications 130 that are more popular may be assigned a higher quantity of virtualized computing environments 160 than the gaming applications 130 that are less popular.

Application hosting platform 102 may include an application load manager 150 that enables loading of application data (generic data 132 and user data 134) of an application 130 into each cache 162 of a set of virtualized computing environments 160 based on the location of the application 130 and the set of virtualized computing environments 160 in the ring. When the user selects the application 130, an instance of the application 130 may be executed on one of the virtualized computing environments 160 based on the location of the application 130 and the virtualized computing environment 160 in the ring and using the data stored in the cache 162 of the virtualized computing environment 160, thereby reducing the time between selection of application 130 and execution of an instance of application 130, as discussed in more detail herein. At least some of generic data 132 and user data 134 can be displayed via a user interface (UI) on each client device accessing an instance of a respective application 130. The amount of generic data 132 and user data 134 can be defined for application 130 by an application developer via application developer platform 104. A user of the respective client device 108 may interact with the instance of the application 130 by engaging, via a GUI provided by the application hosting platform 102, with an instance of the application 130 loaded with the generic data 132 and user data 134. The GUI of the application hosting platform 102 may be presented by a client component of the application hosting platform 102 or be rendered by a web browser hosted by the client device 108.

The virtualized computing environment 160 may be instantiated to facilitate execution of applications 130 for access by client devices 108 and may be deconstructed in response to an event or condition (e.g., in response to a request of a user of client device 108). For example, when a particular event or condition is detected, application load manager 150 may transmit a deconstruct request to server 106, which may cause a hypervisor to deconstruct virtualized computing environment 160.

A user of a respective client device 108 may engage with (e.g., consume, interact, etc.) the application 130 (e.g., via the application hosting platform GUI) that is loaded with the generic data 132 and user data 134 to progress through the application via the respective client device 108. In an illustrative example, applications 130A and 130B may be video game applications (e.g., gaming applications) developed by a video game developer. In another illustrative example, applications 130A and 130B may be content or asset creation applications of a cloud-hosted, collaborative content creation platform. Generic data 132 and user data 134 of a respective video game application 130 can be presented at an application hosting platform GUI on a client device 108 for consumption by a user of client device 108. In at least one embodiment, generic data 132 can include assets, textures, artwork of the application 130, background graphics, title screens, main menu screens, memory allocation of the gaming application 130 on the client device 108, shaders, etc. In at least one embodiment, user data 134 can include data the application 130 loads specifically for a respective client device 108 that has selected the gaming application 130—e.g., for a specific user. For example, user data 134 can include specific user settings (e.g., resolution or shader settings), custom user content (e.g., customizations to a character in a game made by the user), custom key bindings, etc. Accordingly, a user can customize the experience of executing the gaming application 130 at their respective client device 108.

The client devices 108 may include devices, including but not limited to: televisions, smart phones, cellular telephones, personal digital assistants (PDAs), portable media players, netbooks, laptop computers, electronic book readers, tablet computers, desktop computers, set-top boxes, gaming consoles, and the like. As discussed above, the individual client devices 108 may include a client component of the application hosting platform 102 (or a web browser) that provides a GUI allowing a user of client device 108 to request execution of application 130. The GUI may provide a rendered version of the generic data 132 and user data 134 for presentation during a runtime of the application 130 and allow the user to provide input during the runtime of the application 130.

In at least one embodiment, server machine 106 can be separate from a server machine that supports application hosting platform 102. In other embodiments, server machine 106 can be part of the application hosting platform 102. In at least one embodiment, one or more server machines 106, application hosting platforms 102, application developer platforms 104, and data stores 112 can be part of a cloud environment that can be accessed by client devices 108A-N via network 120.

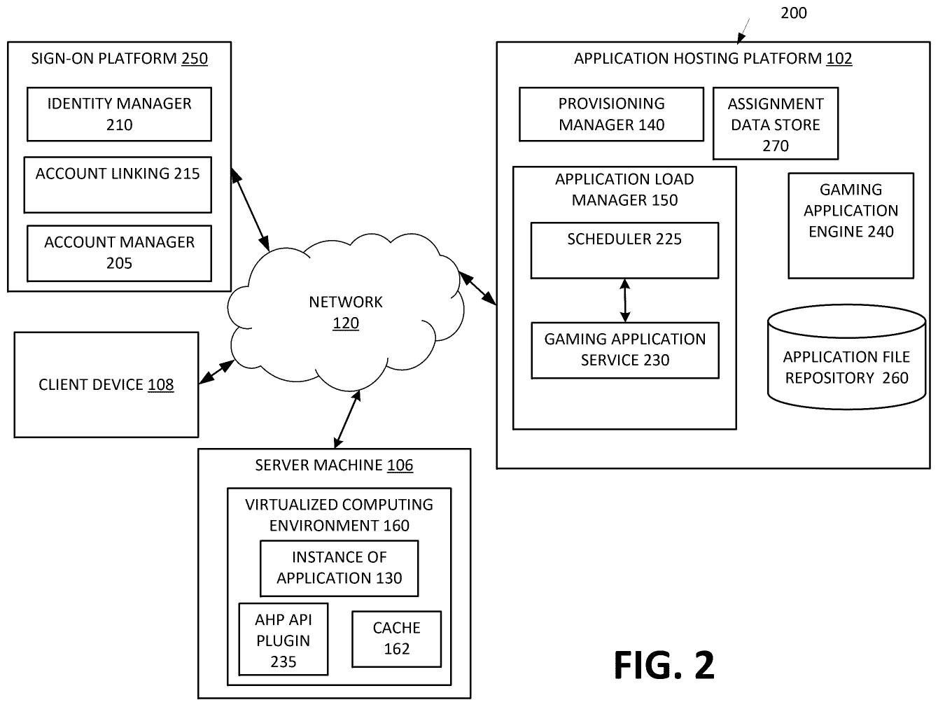

FIG. 2 illustrates a block diagram of a cloud environment 200, according to at least one embodiment. In at least one embodiment, cloud environment 200 includes application hosting platform 102, sign-on platform 250, and one or more servers 106 each providing one or more virtual computing environments 160. Client device 108 is connected to the cloud environment via network 120 as described with reference to FIG. 1. In at least one embodiment, the sign-on platform 250 can include an account manager 205, an account linking component 215, and an identity manager 210. The application hosting platform 102 can include provisioning manager 140 and application load manager 150, which includes a scheduler 225 and a software application service 230. The application hosting platform 102 can also include a gaming application engine 240 and application file repository 260.

In at least one embodiment, account linking component 215 can link an account of a user of client device 108 with an account associated with the application hosting platform 102. In at least one embodiment, account linking component 215 can also determine whether an account of the user of client device 108 associated with an application (e.g., application 130 as described with reference to FIG. 1) is linked or if the user is “logged in.” In at least one embodiment, if the account of the user associated with the application 130 is not linked, the account linking component 215 can facilitate linking the account. In at least one embodiment, if the account of the user associated with the application 130 is linked, the account linking component 215 can store the respective credentials or access and refresh tokens (e.g., tokens used to allow user access to the application 130). In at least one embodiment, the account linking component 215 can link or maintain credentials of many different users for a number of applications 130 hosted by the application hosting platform 130.

In at least one embodiment, account manager 205 can manage an account associated with the application 130 for a user of the client device 108. For example, the account manager 205 can provide a UI that allows the user of the client device 108 to log into an account associated with the application 130.

In at least one embodiment, sign-on platform 250 can include a unique account manager 205 for each unique application 130 hosted at the application hosting platform 130. In at least one embodiment, identity manager 210 can validate (e.g., check) to ensure the credentials of the user are associated with an account of the application 130. That is, the identity manager 210 can enable the user to access their account associated with the application 130.

Application hosting platform 102 can include provisioning manager 140 that can organize some or all of the virtualized computing environments 160 in a ring of virtualized computing environments, identify a number of applications 130 and organize the applications 130 in the ring based on one or more characteristics of the applications 130. Characteristics of applications 130 may include, for example, application popularity, application size, application ranking, etc. Based on the ring organization of the virtualized computing environments 160 and the applications 130, provisioning manager 140 can assign multiple sets of virtualized computing environments 160 to multiple applications 130, where each set of virtualized computing environments 160 is assigned to a particular application 130 (e.g., a first set of virtualized computing environments 160 is assigned to a first application 130, a second set of virtualized computing environments 160 is assigned to a second application 130, a third set of virtualized computing environments 160 is assigned to a third application 130, etc.). In at least one embodiment, provisioning manager 140 temporarily rotates the sets of virtualized computing environments 160 on the ring based on expected wear and tear characteristics of respective applications 130 such that wear and tear characteristics of virtualized computing environments 160 are spread evenly among the virtualized computing environments 160. In at least one embodiment, expected wear and tear characteristics of each application 130 can be determined by measuring usage of resources (GPU, CPU, disk, etc.) by respective application 130 over time during multiple cloud sessions, and monitoring relevant resource usage parameters such as GPU/CPU usage percentage, GPU/CPU maximum usage, read/write bytes, etc., which can indicate the application's heavy usage of GPU/CPU or disk.

In at least one embodiment, provisioning manager 140 stores assignment data (association of a unique identifier of a particular application 130 with a corresponding set of one or more virtualized computing environments 160) in assignment data store 270, which can be, for example, a database, a table, a file, etc. In at least one embodiment, provisioning manager 140 can modify the assignment for the application 130 if characteristics of the applications change. For example, if application 130 becomes more popular than another application, one or more virtualized computing environments from the set previously assigned to the other application can be reassigned to the application 130. In at least one embodiment, provisioning manager 140 can assign multiple applications to the same virtualized computing environment (e.g., for the applications that have low popularity).

Application hosting platform 102 can further include application file repository 260 that stores files of various applications 130 (including, for example, generic and user data of applications 130) registered with the application hosting platform 102, and application load manager 150 that can enable loading of an instance of the application 130 into virtualized computing environment 160. In at least one embodiment, application load manager 150 or provisioning manager 140 pre-loads application data of each application 130 into caches 162 of corresponding sets of virtualized computing environments 160 assigned to the application 130 (e.g., based on assignment data in assignment data store 270). When the user selects an application 130, an instance of the application 130 may be executed on a virtualized computing environment 160 selected from the assigned set of virtualized computing environments 160 based on the locations of applications 130 and virtualized computing environments 160 in the ring and using the data stored in the cache 162 of that virtualized computing environment 160. In at least one embodiment, the selected virtualized computing environment 160 is an available virtualized computing environment in the ring from the assigned set of virtualized computing environments 160. For example, the selected virtualized computing environment 160 is the first available virtualized computing environment in the ring from the assigned set of virtualized computing environments 160. In at least one embodiment, if the assigned set of virtualized computing environments 160 does not include an available virtual computing environment, an available virtual computing environment from another set of virtual computing environments 160 in the ring is selected for the instance of the application 130.

In at least one embodiment, the application hosting platform 102 can receive a request (e.g., a user request) to terminate the application 130, and can stop the execution of the instance of the application 130, causing the virtualized computing environment 160 to become available for subsequent allocations in the respective set of virtualized computing environments 160. In at least one embodiment, the application hosting platform 102 can activate and/or deactivate virtualized computing environments 160 based on one or more parameters (e.g., time of day, day of week or month, etc.).

In at least one embodiment, the application hosting platform 102 can cause the instance of the application 130 at the virtualized computing environment 160 to stream content of the application to the client device 108—e.g., to the application hosting platform (AHP) GUI as described with reference to FIG. 1. In one embodiment, the application 130 can be an example of a gaming application (e.g., a video game) or a collaborative content creation platform or application. In such examples, the virtualized computing environment 160 can store or load an instance of the gaming application. The instance of the gaming application can stream gaming content to the client device 108 when a user of the client device initiates a session.

In at least one embodiment, the application load manager 150 of the application hosting platform 102 can include a scheduler 225. In one embodiment, the scheduler 225 may be configured to initiate or launch an instance of a gaming application 130 for a user of the client device 108. In one embodiment, the scheduler 225 can issue a request to allocate (e.g., create) a virtualized computing environment 160 at server 106. For example, the scheduler 225 can initiate creating the virtualized computing environment 160 by sending a request to a virtual system manager (that manages creation, deconstruction, etc., of virtualized computing environments 160 across servers 106) or directly to a hypervisor or host operating system of server 106.

In at least one embodiment, the application 130 is integrated with an application hosting platform (AHP) API plugin 235 (e.g., a designated software development kit (SDK)) that can be configured to communicate with the application hosting platform 102 via a predefined set of API commands to launch and/or load an instance of gaming application 130 on virtualized computing environment 160. In at least one embodiment, application hosting platform 102 can have a unique AHP API plugin for each software application 130 it hosts. Alternatively, a common AHP API plugin can be operable with all software applications hosted/registered with the application hosting platform 102.

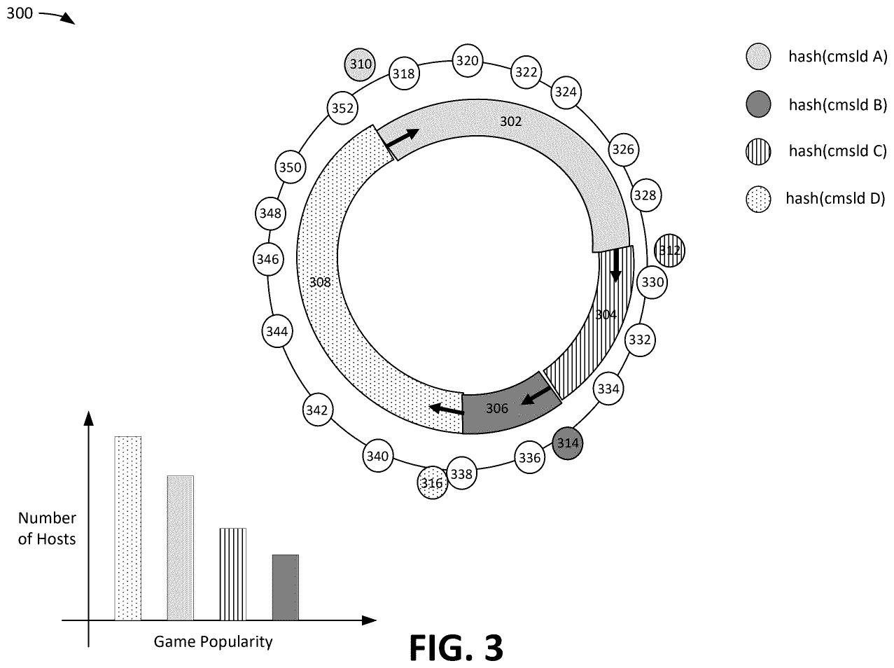

FIG. 3 illustrates an example ring-based allocation 300 of applications to virtualized computing environments using application characteristics, in accordance with at least at least one embodiment.

A provisioning manager of a cloud computing platform may identify one or more virtualized computing environments capable of hosting one or more applications. The virtualized computing environments may be, for example, virtual machines or containers. Additionally, the provisioning manager of the cloud computing platform may identify one or more applications (for example, gaming applications) provided by an application hosting platform. Further, the provisioning manager may organize the applications in a ring of applications based on one or more characteristics of the applications. For example, applications that are more popular may be assigned to a larger portion of the ring than applications that are less popular. Therefore, the applications that are more popular may be assigned a higher quantity of virtualized computing environments than the applications that are less popular.

As shown in FIG. 3, the provisioning manager identifies four applications. For example, the provisioning manager may identify a first application 302, a second application 304, a third application 306, and a fourth application 308. Each application may be associated with a corresponding identifier, such as a content management server identifier (ID) (cmsId). For example, the first application 302 may be associated with cmsId A 310, the second application 304 may be associated with cmsId B 312, the third application 306 may be associated with cmsId C 314, and the fourth application 308 may be associated with cmsId D 316.

As further shown in FIG. 3, a cloud computing platform provides eighteen virtualized computing environments that are capable of executing instances of the four applications. The virtualized computing environments are shown as virtualized computing environments 318 through 352. The provisioning manager may organize the applications in a ring of applications based on one or more characteristics of the applications. In some aspects, the provisioning manager may organize the applications in the ring of applications based on respective popularities of the applications. For example, based on respective popularities of the applications, the provisioning manager may allocate thirty percent of the ring to the first application 302, twenty percent of the ring to the second application 304, ten percent of the ring to the third application 306, and forty percent of the ring to the fourth application 308.

The provisioning manager may assign the virtualized computing environments to one or more applications of the multiple applications based on the respective locations of the virtualized computing environments and the applications in the ring of applications. For example, the provisioning manager may assign six virtualized computing environments (318 through 328) to the first application 302, three virtualized computing environments (330 through 334) to the second application 304, two virtualized computing environments (336 and 338) to the third application 306, and seven virtualized computing environments (340 through 352) to the fourth application.

The provisioning manager may store data associated with the applications in the caches of the assigned virtualized computing environments. For example, the provisioning manager may store data associated with the first application 302 in the caches of the corresponding six virtualized computing environments (318 through 328), data associated with the second application 304 in the caches of the corresponding three virtualized computing environments (330 through 334), data associated with the third application 306 in the caches of the corresponding two virtualized computing environments (336 and 338), and data associated with the fourth application 308 in the caches of the corresponding seven virtualized computing environments (340 through 352). When a user selects one of the applications, an instance of the application may be executed on a corresponding virtualized computing environment using the data stored in the cache of the virtualized computing environment.

While FIG. 3 shows four applications and eighteen virtualized computing environments organized in a ring structure, it is understood that this is provided for the purposes of example only. For example, any number of applications and virtualized computing environments can be identified, any number of virtualized computing environments can be assigned to any number of applications, and any type of structure or list can be used for organizing and assigning the virtualized computing environments and corresponding applications.

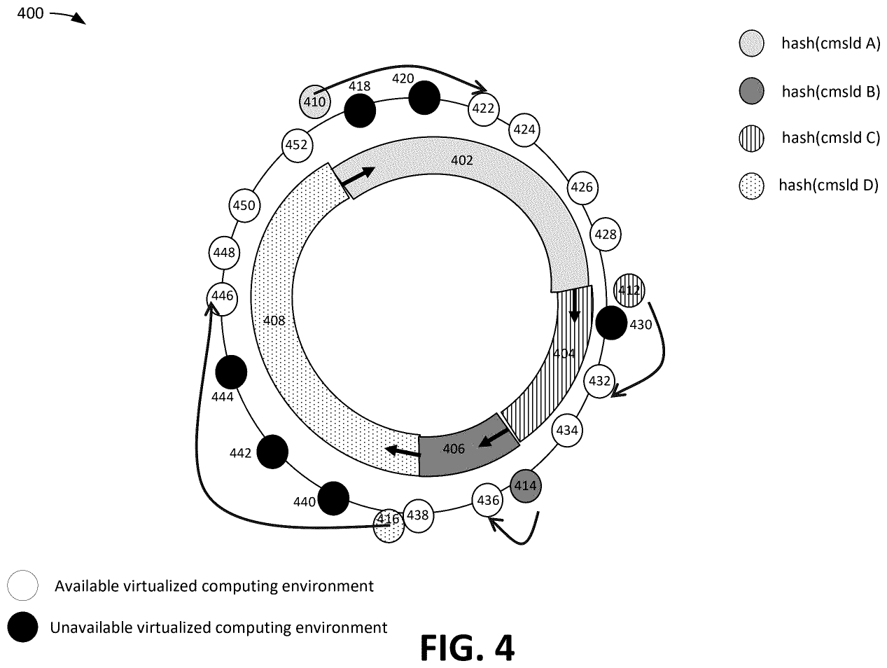

FIG. 4 illustrates an example ring-based allocation 400 of applications to virtualized computing environments using virtualized computing environment availability, in accordance with at least at least one embodiment. Virtualized computing environments 418 through 452 (corresponding, respectively, to virtualized computing environments 318 through 352 in example 300) are capable of hosting applications 402 through 408 (corresponding, respectively, to applications 302 through 308 in example 300).

In some aspects, when a user request to execute the first application 402 is received, an available virtualized computing environment from the set assigned to the first application 402 can be selected to execute the instance of the first application 402. For example, the instance of the first application 402 can be executed on a first available virtualized computing environment of the set of virtualized computing environments assigned to the first application 402. As shown, virtualized computing environments 418 and 420 are unavailable (for example, may be in use) whereas virtualized computing environments 422 through 428 are available. Therefore, the instance of the first application 402 can be executed on the virtualized computing environment 422.

In some aspects, when a user request to execute a second application 404 is received, an available virtualized computing environment from the set assigned to the second application 404 can be selected to execute the instance of the second application 404. For example, the instance of the second application 404 can be executed on a first available virtualized computing environment of the set of virtualized computing environments assigned to the first application 404. As shown, virtualized computing environment 430 is unavailable (for example, may be in use) whereas virtualized computing environments 432 and 434 are available. Therefore, the instance of the second application 404 can be executed on the virtualized computing environment 432.

In some aspects, when a user request to execute a third application 406 is received, an available virtualized computing environment from the set assigned to the third application 406 can be selected to execute the instance of the third application 406. For example, the instance of the third application 406 can be executed on a first available virtualized computing environment of the set of virtualized computing environments assigned to the third application 406. As shown, virtualized computing environments 436 and 438 are both available. Therefore, the instance of the third application 406 can be executed on the virtualized computing environment 436.

In some aspects, when a user request to execute a fourth application 408 is received, an available virtualized computing environment from the set assigned to the fourth application 408 can be selected to execute the instance of the fourth application 408. For example, the instance of the fourth application 408 can be executed on a first available virtualized computing environment of the set of virtualized computing environments assigned to the fourth application 408. As shown, virtualized computing environments 440 through 444 are unavailable (for example, may be in use) whereas virtualized computing environments 446 through 452 are available. Therefore, the instance of the fourth application 408 can be executed on the virtualized computing environment 446.

In some aspects, the virtualized computing environments can be activated and/or deactivated based on one or more parameters, such as based on a time parameter. For example, it can be determined that applications are executed more frequently during a first time of day (such as in the evening) than during a second time of day (such as in the morning). As such, most or all of the virtualized computing environments may be activated during the first time of day in order to enable the applications to be executed more quickly during the first time of day, and some of the virtualized computing environments may be deactivated during the second time of day in order to reduce a power consumption by the virtualized computing environments. For example, during the first time of day, each of virtualized computing environments 418 through 428 can be activated for the first application 402, while during the second time of day, virtualized computing environments 418 and 420 can be deactivated for the first application 402 in order to reduce power consumption.

In some aspects, the provisioning manager may re-assign a virtualized computing environment from one application to another application based on one or more conditions. For example, based on detecting that the second application 404 is becoming more popular than the first application 402, the provisioning manager may reassign a unique identifier of the second application 404 from one virtualized computing environment to another virtualized computing environment. Additionally, application data associated with the first application 404 can be deleted from the cache of the virtualized computing environment 428 and application data associated with the second application 404 can be stored in a cache of the virtualized computing environment 428. In some aspects, the cache of each virtualized computing environment may store data for a single application. In other aspects, the cache of at least one virtualized computing environment may store data for multiple applications. This may enable the virtualized computing environment to efficiently host any game of the multiple applications.

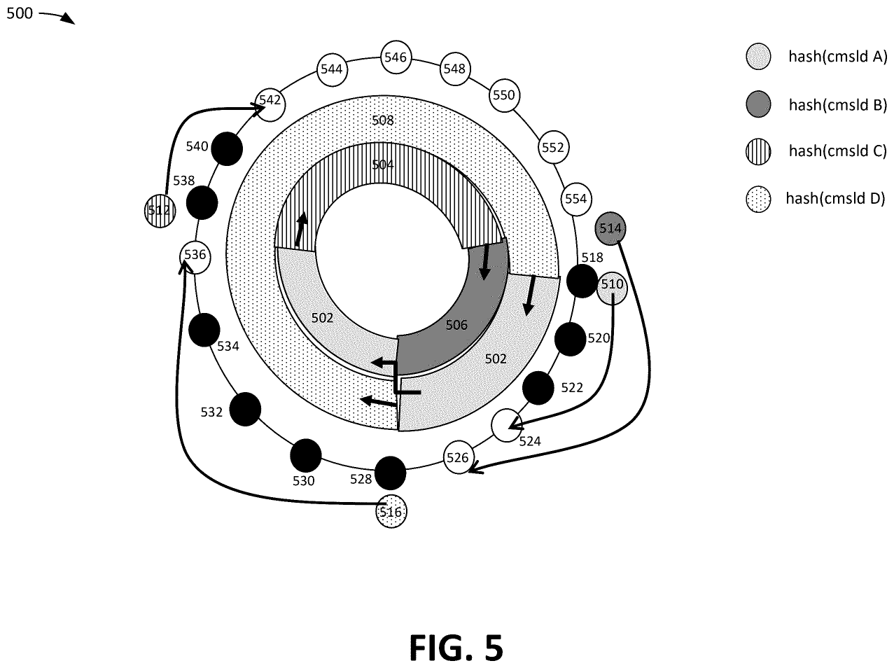

FIG. 5 illustrates an example allocation 500 of applications to virtualized computing environments using multiple rings, in accordance with at least at least one embodiment.

In some aspects, the provisioning manager may organize the applications and virtualized computing environments in multiple rings. For example, the provisioning manager may organize the applications and virtualized computing environments in multiple overlapping rings. This may enable storage of data for multiple applications in caches of the virtualized computing environments. For example, in a two-ring structure, the cache of each virtualized computing environment may store data for two applications.

As shown in FIG. 5, the provisioning manager identifies four applications. For example, the provisioning manager may identify a first application 502, a second application 504, a third application 506, and a fourth application 508. Each application may be associated with a corresponding identifier. For example, the first application 502 may be associated with cmsId A 510, the second application 504 may be associated with cmsId B 512, the third application 506 may be associated with cmsId C 514, and the fourth application 508 may be associated with cmsId D 516.

As further shown in FIG. 5, a cloud computing platform may provide nineteen virtualized computing environments that are capable of executing instances of the four applications. The virtualized computing environments are shown as virtualized computing environments 518 through 554. The provisioning manager may organize the applications in the ring based on one or more characteristics of the applications. For example, the provisioning manager may organize the applications in the ring of applications based on respective popularities of the applications.

As shown in example 500, the first application 502 is associated with virtualized computing environments 518 through 536, the second application 504 is associated with virtualized computing environments 538 through 554, the third application 506 is associated with virtualized computing environments 518 through 526, and the fourth application 508 is associated with virtualized computing environments 528 through 554. From the perspective of the virtualized computing environments, virtualized computing environment 518 stores data for applications 502 and 506, virtualized computing environment 520 stores data for applications 502 and 506, virtualized computing environment 522 stores data for applications 502 and 506, virtualized computing environment 524 stores data for applications 502 and 506, virtualized computing environment 526 stores data for applications 502 and 506, virtualized computing environment 528 stores data for applications 502 and 508, virtualized computing environment 530 stores data for applications 502 and 508, virtualized computing environment 532 stores data for applications 502 and 508, virtualized computing environment 534 stores data for applications 502 and 508, virtualized computing environment 536 stores data for applications 502 and 508, virtualized computing environment 538 stores data for applications 504 and 508, virtualized computing environment 540 stores data for applications 504 and 508, virtualized computing environment 542 stores data for applications 504 and 508, virtualized computing environment 544 stores data for applications 504 and 508, virtualized computing environment 546 stores data for applications 504 and 508, virtualized computing environment 548 stores data for applications 504 and 508, virtualized computing environment 550 stores data for applications 504 and 508, virtualized computing environment 552 stores data for applications 504 and 508, virtualized computing environment 554 stores data for applications 504 and 508.

In some aspects, when a user request to execute a first application 502 is received, an available virtualized computing environment from the set assigned to the first application 502 can be selected to execute the instance of the first application 502. For example, the instance of the first application 502 can be executed on a first available virtualized computing environment of the multiple virtualized computing environments assigned to the first application 502. As shown, virtualized computing environments 518 through 522 and virtualized computing environments 528 through 524 are unavailable (for example, may be in use) whereas virtualized computing environments 524, 526 and 536 are available. Therefore, the instance of the first application 502 can be executed on the virtualized computing environment 524.

In some aspects, when a user request to execute a second application 504 is received, an available virtualized computing environment from the set assigned to the second application 504 can be selected to execute the instance of the second application 504. For example, the instance of the second application 504 can be executed on a first available virtualized computing environment of the multiple virtualized computing environments assigned to the second application 504. As shown, virtualized computing environments 538 and 540 are unavailable (for example, may be in use) whereas virtualized computing environments 542 through 554 are available. Therefore, the instance of the second application 504 can be executed on the virtualized computing environment 542.

In some aspects, when a user request to execute a third application 506 is received, an available virtualized computing environment from the set assigned to the third application 506 can be selected to execute the instance of the third application 506. For example, the instance of the third application 506 can be executed on a first available virtualized computing environment of the multiple virtualized computing environments assigned to the third application 506. As shown, virtualized computing environments 518 through 522 are unavailable (for example, may be de-activated) and virtualized computing environment 524 is assigned to the first application 502, whereas virtualized computing environment 526 is available. Therefore, the instance of the third application 506 can be executed on the virtualized computing environment 526.

In some aspects, when a user request to execute a fourth application 508 is received, an available virtualized computing environment from the set assigned to the fourth application 508 can be selected to execute the instance of the fourth application 508. For example, the instance of the fourth application 508 can be executed on a first available virtualized computing environment of the multiple virtualized computing environments assigned to the fourth application 508. As shown, virtualized computing environments 528 through 534 and virtualized computing environments 538 through 540 are unavailable (for example, may be de-activated) and virtualized computing environment 542 is assigned to the second application 504, whereas virtualized computing environments 536 and 544 through 544 are available. Therefore, the instance of the fourth application 508 can be executed on the virtualized computing environment 536.

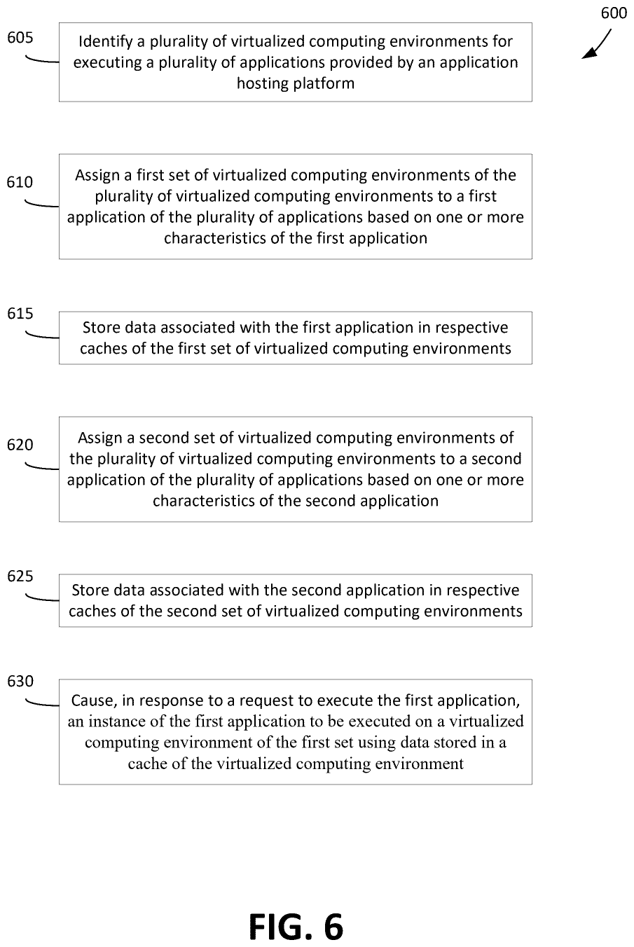

FIG. 6 illustrates a flow diagram of an example method 600 of allocating application hosting platforms in a virtualized computing environment, in accordance with at least at least one embodiment. Method 600 may be performed using one or more processing units or processors (e.g., CPUs, GPUs, accelerators, physics processing units (PPUs), data processing units (DPUs), etc.), which may include (or communicate with) one or more memory devices. According to some aspects of the disclosure, method 600 may be performed using a processing device. According to some aspects of the disclosure, method 600 may be performed using processing units of application hosting platform 102 of FIG. 1. According to some aspects of the disclosure, processing units performing method 600 may be executing instructions stored on a non-transient computer-readable storage media. According to some aspects of the disclosure, method 600 may be performed using multiple processing threads (e.g., CPU threads and/or GPU threads), individual threads executing one or more individual functions, routines, subroutines, or operations of the method. According to some aspects of the disclosure, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. According to some aspects of the disclosure, one or more operations shown in FIG. 6 may not always be performed.

Referring to FIG. 6, at block 605, processing units executing method 600 can identify a plurality of virtualized computing environments for executing a plurality of applications provided by an application hosting platform. In some aspects, the plurality of virtualized computing environments is organized in a ring of virtualized computing environments.

At block 610, processing units can assign a first set of virtualized computing environments of the plurality of virtualized computing environments to a first application of the plurality of applications based on one or more characteristics of the first application. In some aspects, the one or more characteristics of the first application include a size of the first application, a popularity of the first application, and/or a ranking of the first application. In some aspects, assigning the first set of virtualized computing environments to the first application comprises assigning a unique identifier of the first application to the first set of virtualized computing environments.

At block 615, processing units can store data associated with the first application in respective caches of the first set of virtualized computing environments.

At block 620, processing units can assign a second set of virtualized computing environments of the plurality of virtualized computing environments to a second application of the plurality of applications based on one or more characteristics of the second application. The second set of virtualized computing environments may be different than the first set of virtualized computing environments. In some aspects, the one or more characteristics of the second application include a size of the second application, a popularity of the second application, and/or a ranking of the second application. In some aspects, assigning the second set of virtualized computing environments to the second application comprises assigning a unique identifier of the second application to the second set of virtualized computing environments.

At block 625, processing units can store data associated with the second application in respective caches of the second set of virtualized computing environments.

At block 630, processing units cause, in response to a request to execute the first application, an instance of the first application to be executed on a virtualized computing environment of the first set of virtualized computing environments using data stored in a cache of the virtualized computing environment. In some aspects, assignments of virtualized computing environments for the first and second applications are stored in an assignment data store and are then used to select an available virtualized computing environment from the assigned virtualized computing environments in the ring. In some aspects, the selected virtualized computing environment is a first available virtualized computing environment in the ring that is associated with the first set of virtualized computing environments.

In some aspects, processing units can receive a request to terminate the first application, and can re-assign the virtualized computing environment as an available virtualized computing environment in the first set of virtualized computing environments.

In some aspects, processing units can activate a virtualized computing environment of the first set of virtualized computing environments, or de-activate the virtualized computing environment of the first set of virtualized computing environments, based on one or more parameters. In some aspects, the one or more parameters include a time of day parameter.

In some aspects, processing units can switch a virtualized computing environment from the first set of virtualized computing environments to the second set of virtualized computing environments based on the one or more characteristics of the first application or the one or more characteristics of the second application.

In some aspects, processing units can determine the first set of virtualized computing environments and the second set of virtualized computing environments based on the one or more characteristics of the first application and the one or more characteristics of the second application. In some aspects, the first set of virtualized computing environments and the second set of virtualized computing environments are rotated temporally on the ring for reasons that include but are not limited to the expected wear and tear characteristics of the first and second applications.

In some aspects, each virtualized computing environment of the plurality of virtualized computing environments stores application data for a single application in the cache of the virtualized computing environment. In some other aspects, at least one virtualized computing environment of the plurality of virtualized computing environments stores application data for two or more applications of the plurality of applications in the cache of the virtualized computing environment.

In some aspects, processing units can receive a request to execute an application of the two or more applications, and execute an instance of the application in the at least one virtualized computing environment that stores the application data for the two or more applications in the cache of the virtualized computing environment.

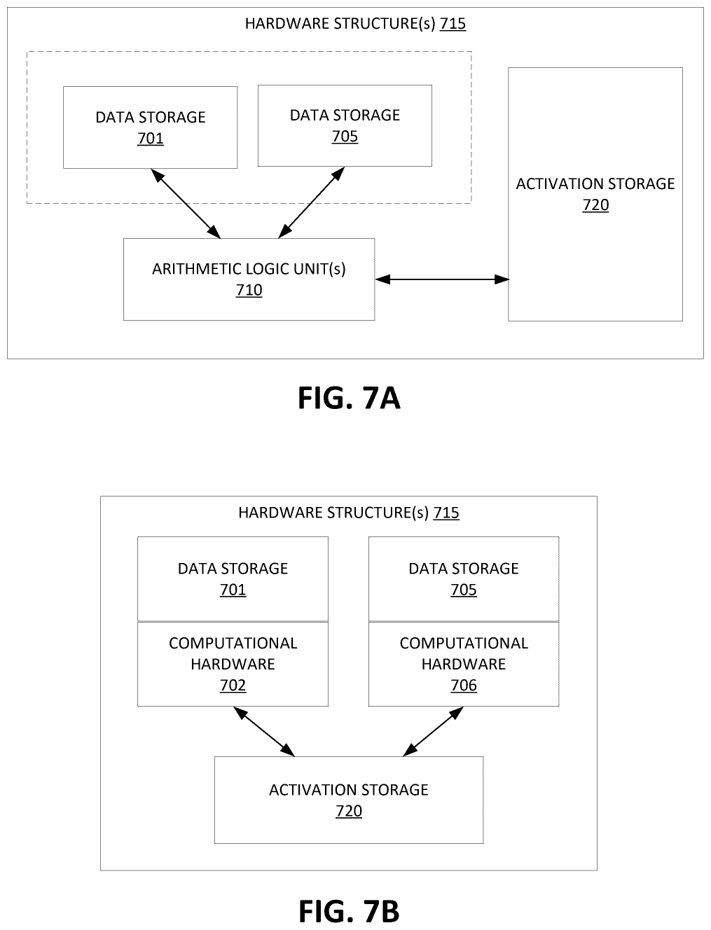

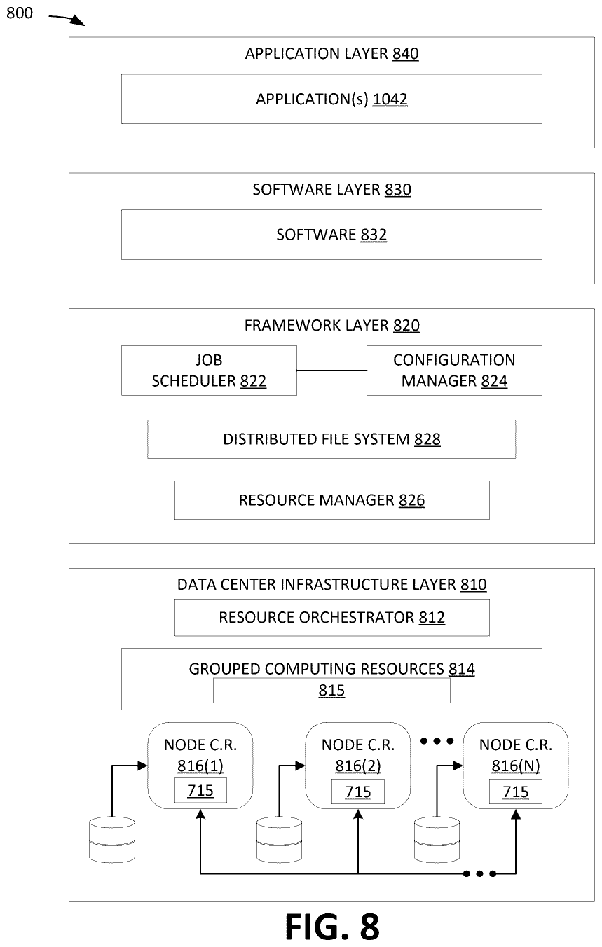

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory.

Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

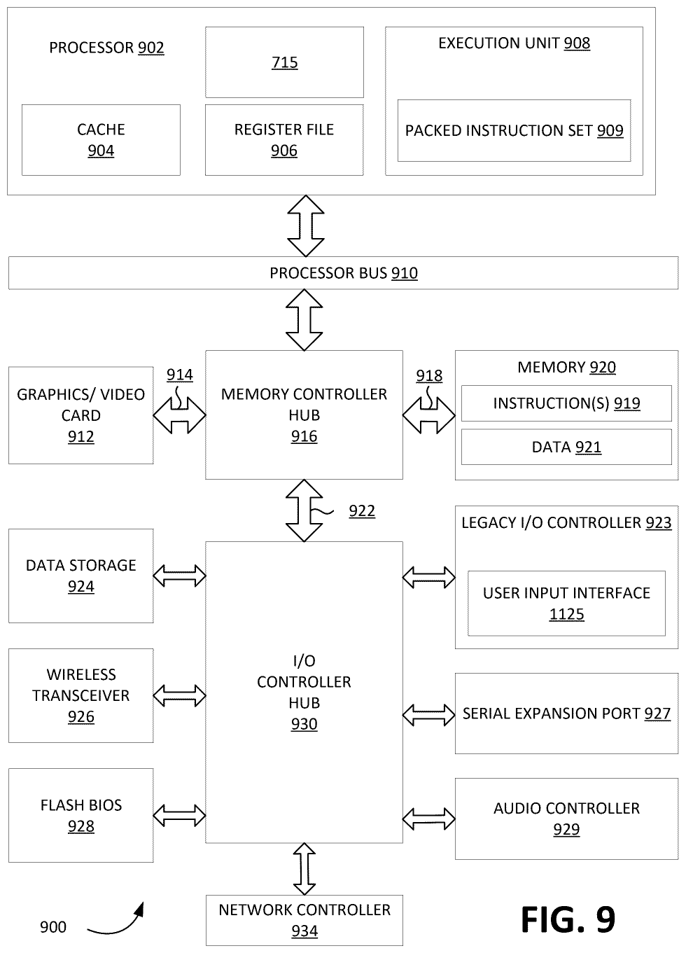

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934, which may include in at least one embodiment, a data processing unit. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

FIG. 10 is a block diagram illustrating a system 1000 for utilizing a processor 1010, according to at least one embodiment. In at least one embodiment, system 1000 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, audio unit 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

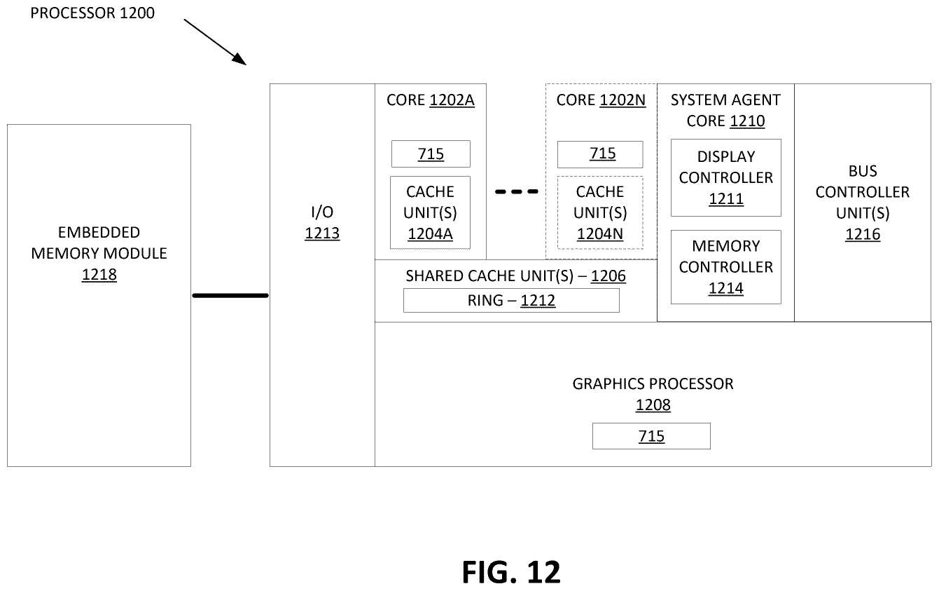

FIG. 11 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, edge, or embedded devices.

In at least one embodiment, system 1100 may include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 may also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 may have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, may be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 may be a dynamic random access memory (DRAM) device, a static random access memory (SRAM) device, flash memory device, phase-change memory device, or some other memory device having suitable performance to serve as process memory. In at least one embodiment memory device 1120 may operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 may connect to processor(s) 1102. In at least one embodiment display device 1111 may include one or more of an internal display device, as in a mobile electronic device or a laptop device or an external display device attached via a display interface (e.g., DisplayPort, etc.). In at least one embodiment, display device 1111 may include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 may connect via a storage interface (e.g., SATA) or via a peripheral bus, such as a Peripheral Component Interconnect bus (e.g., PCI, PCI Express). In at least one embodiment, touch sensors 1125 may include touch screen sensors, pressure sensors, or fingerprint sensors. In at least one embodiment, wireless transceiver 1126 may be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and may be, for example, a unified extensible firmware interface (UEFI). In at least one embodiment, network controller 1134 may enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 may also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as an external graphics processor. In at least one embodiment, platform controller hub 1130 and/or memory controller 1116 may be external to one or more processor(s) 1102. For example, in at least one embodiment, system 1100 may include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1108. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

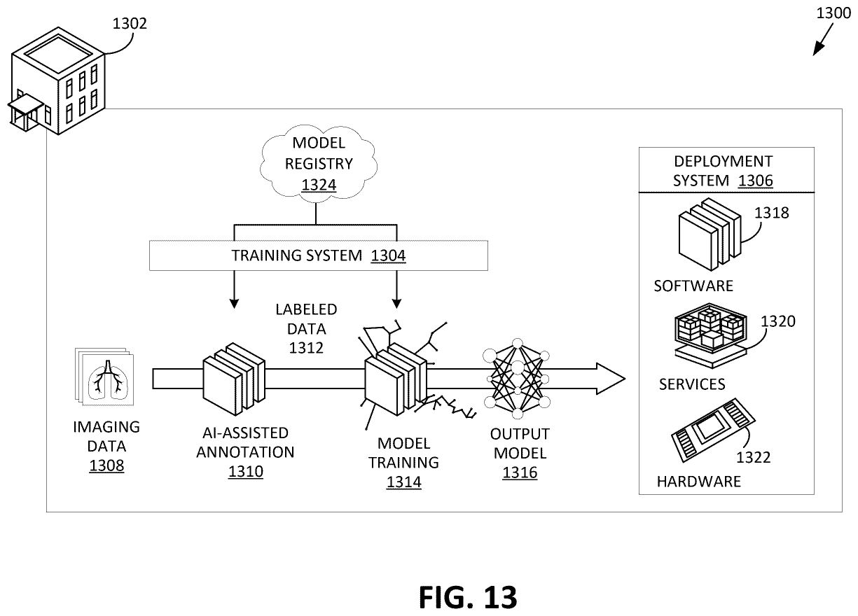

FIG. 12 is a block diagram of a processor 1200 having one or more processor cores 1202A-1202N, an integrated memory controller 1213, and an integrated graphics processor 1208, according to at least one embodiment. In at least one embodiment, processor 1200 may include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1213 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1213. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 may be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

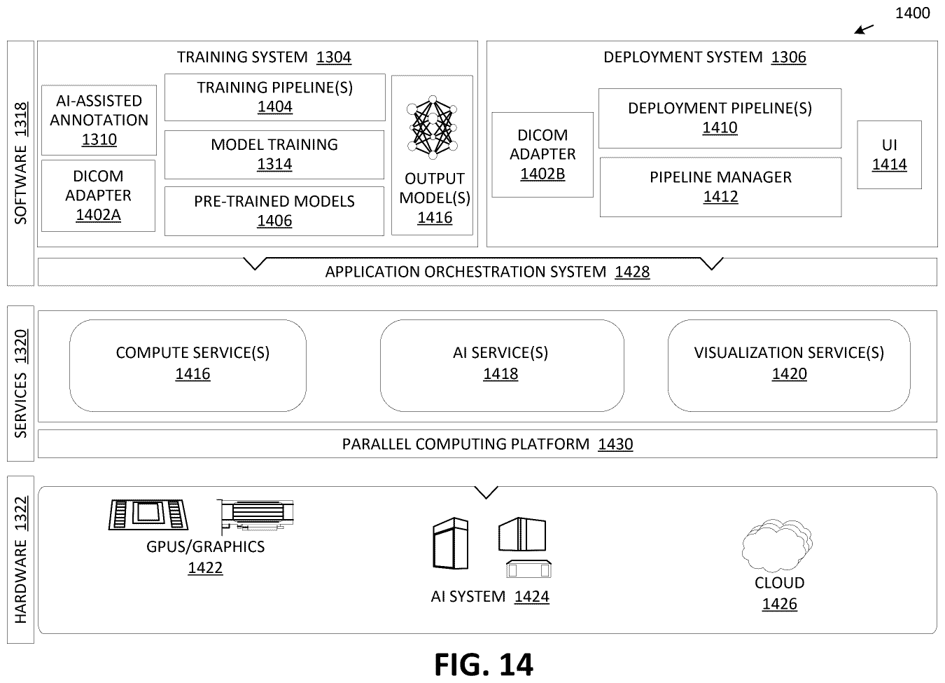

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

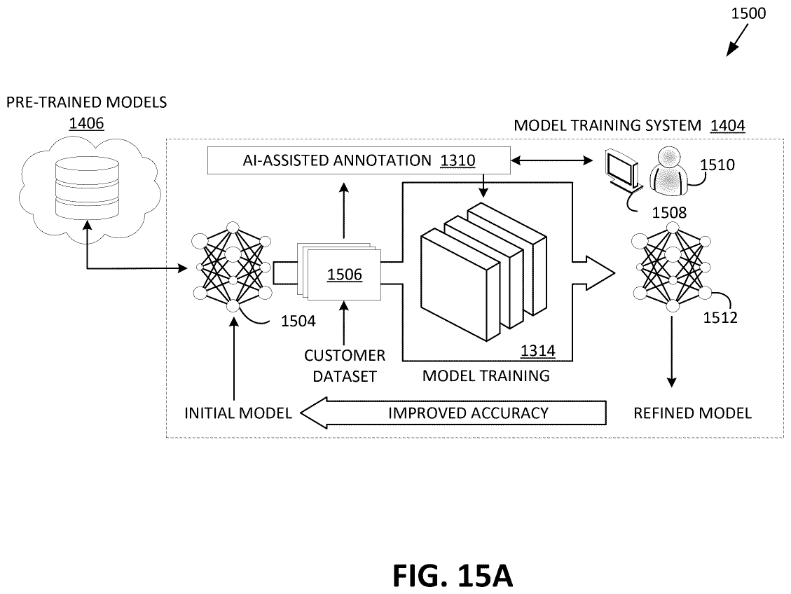

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 14) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 14), a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 14)). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 16B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an MRI machine, there may be a first deployment pipeline 1410, and where image enhancement is desired from output of an MRI machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify, or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 12) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in at least one embodiment, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<12 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. In at least one embodiment, GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426 —or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs 1422, in addition to DPUs, CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

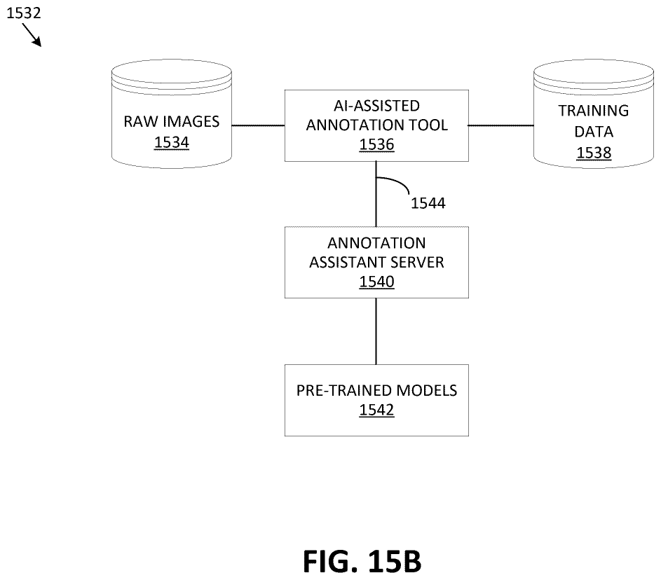

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so training or retraining 1314 may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., image data 1308 of FIG. 13).

In at least one embodiment, pre-trained models 1406 may be stored in a data store, or registry (e.g., model registry 1324 of FIG. 13). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 13).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1404. In at least one embodiment, pre-installed annotation tools may be improved over time as new labeled clinic data 1312 is added.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
identifying a plurality of virtualized computing environments for executing a plurality of applications;
assigning a first set of virtualized computing environments of the plurality of virtualized computing environments to a first application of the plurality of applications based on one or more characteristics of the first application, wherein data associated with the first application is stored in respective caches of the first set of virtualized computing environments;
assigning a second set of virtualized computing environments of the plurality of virtualized computing environments to a second application of the plurality of applications based on one or more characteristics of the second application, the second set of virtualized computing environments being different than the first set of virtualized computing environments, wherein data associated with the second application is stored in respective caches of the second set of virtualized computing environments; and
causing, responsive to a request to execute the first application, an instance of the first application to be executed on a virtualized computing environment of the first set of virtualized computing environments using data stored in a cache of the virtualized computing environment.

2. The method of claim 1, wherein the one or more characteristics of the first application include at least one of a size of the first application, a popularity of the first application, or a ranking of the first application, and wherein the one or more characteristics of the second application include at least one of a size of the second application, a popularity of the second application, or a ranking of the second application.

3. The method of claim 1, wherein the plurality of virtualized computing environments is organized in a ring of virtualized computing environments, and wherein the virtualized computing environment is an available virtualized computing environment selected from the ring of virtualized computing environments.

4. The method of claim 3, wherein the available virtualized computing environment in the ring of virtualized computing environments is a first available virtualized computing environment selected from the first set of virtualized computing environments in the ring of virtualized computing environments.

5. The method of claim 3, wherein when the first set of virtualized computing environments does not include an available virtualized computing environment, selecting a virtualized computing environment for a second instance of the first application from at least a portion of the second set of virtualized computing environments in the ring of virtualized computing environments, wherein at least the portion of the second set of virtualized computing environments in the ring of virtualized computing environments is also assigned to the first application.

6. The method of claim 1, further comprising:
receiving a request to terminate the first application; and
re-assigning the virtualized computing environment as an available virtualized computing environment in the first set of virtualized computing environments.

7. The method of claim 1, further comprising activating a particular virtualized computing environment of the first set of virtualized computing environments, or de-activating the particular virtualized computing environment of the first set of virtualized computing environments, based on one or more parameters.

8. The method of claim 7, wherein the one or more parameters comprise a time-of-day parameter or a day-of-week parameter.

9. The method of claim 1, further comprising switching a particular virtualized computing environment from the first set of virtualized computing environments to the second set of virtualized computing environments based on at least one of the one or more characteristics of the first application or the one or more characteristics of the second application.

10. The method of claim 1, further comprising determining the first set of virtualized computing environments and the second set of virtualized computing environments from the plurality of virtualized computing environments based on the one or more characteristics of the first application and the one or more characteristics of the second application.

11. The method of claim 10, wherein the first set of virtualized computing environments and the second set of virtualized computing environments are rotated temporally on a ring of virtualized computing environments based on at least one of expected wear and tear characteristics of the first application or expected wear and tear characteristics of the second application.

12. The method of claim 1, wherein assigning the first set of virtualized computing environments to the first application comprises assigning a first unique identifier of the first application to the first set of virtualized computing environments, and wherein assigning the second set of virtualized computing environments to the second application comprises assigning a second unique identifier of the second application to the second set of virtualized computing environments.

13. The method of claim 1, wherein at least one particular virtualized computing environment of the plurality of virtualized computing environments stores application data for two or more applications of the plurality of applications in the cache of the particular virtualized computing environment.

14. The method of claim 13, further comprising:
causing, responsive to a request to execute a specific application of the two or more applications, an instance of the specific application to be executed on the at least one particular virtualized computing environment that stores the application data for the two or more applications in the cache of the particular virtualized computing environment.

15. A system comprising:
a memory; and
at least one processor, coupled to the memory, to perform operations comprising:
designating a first set of virtualized computing environments of a plurality of virtualized computing environments to execute a first application of the plurality of applications based on one or more characteristics of the first application;
designating a second set of virtualized computing environments of the plurality of virtualized computing environments to execute a second application of the plurality of applications based on one or more characteristics of the second application, the second set of virtualized computing environments being different than the first set of virtualized computing environments; and
causing, responsive to a request to execute the first application, an instance of the first application to be executed on a virtualized computing environment of the first set of virtualized computing environments using data stored in a respective cache of the virtualized computing environment.

16. The system of claim 15, wherein the one or more characteristics of the first application include at least one of a size of the first application, a popularity of the first application, or a ranking of the first application, and wherein the one or more characteristics of the second application include at least one of a size of the second application, a popularity of the second application, or a ranking of the second application.

17. The system of claim 15, wherein the plurality of virtualized computing environments is organized in a ring of virtualized computing environments, and wherein the virtualized computing environment is an available virtualized computing environment selected from the ring of virtualized computing environments.

18. The system of claim 17, wherein the available virtualized computing environment in the ring of virtualized computing environments is a first available virtualized computing environment selected from the first set of virtualized computing environments in the ring of virtualized computing environments.

19. A non-transitory computer-readable medium storing instructions thereon, wherein the instructions, when executed by a processor, cause the processor to:
assign one or more sets of virtualized computing environments of a plurality of virtualized computing environments to one or more applications of a plurality of applications based on one or more characteristics of the one or more applications; and
causing, responsive to a request to execute a particular application of the plurality of applications, an instance of the particular application to be executed on a particular virtualized computing environment of a set of virtualized computing environments assigned to the particular application using data stored in a respective cache of the particular virtualized computing environment.

20. The non-transitory computer-readable medium of claim 19, wherein the plurality of virtualized computing environments is organized in a ring of virtualized computing environments, and wherein the particular virtualized computing environment is an available virtualized computing environment selected from the set of virtualized computing environments in the ring of virtualized computing environments assigned to the particular application.
